(19) United States
(12) Patent Application Publication
(10) Pub. No.: US 2025/0329851 A1
(43) Pub. Date: Oct. 23, 2025

(54) ENERGY STORAGE POWER SUPPLY

(71) Applicant: SHENZHEN HELLO TECH ENERGY CO., LTD, Shenzhen (CN)

(72) Inventors: Yong WU, Shenzhen (CN); Jie ZHANG, Shenzhen (CN)

(21) Appl. No.: 19/251,863

(22) Filed: Jun. 27, 2025

(30) Foreign Application Priority Data
Jul. 4, 2024 (CN) 202410895892.X
Jul. 4, 2024 (CN) 202421581438.9
Nov. 25, 2024 (CN) 202411709371.7
Jan. 16, 2025 (CN) 202510080365.8

(51) Int. Cl. H01M 50/262; H01M 10/42; H01M 50/213; H01M 50/251; H01M 50/271

(52) U.S. Cl. CPC H01M 50/262; H01M 10/425; H01M 50/213; H01M 50/251; H01M 50/271; H01M 2220/10

(57) ABSTRACT

Provided is an energy storage power supply. The energy storage power supply includes a shell, a battery module, and an inverter. The shell includes a first case and a second case detachably connected to the first case. The first case has a first inner wall opposite to the second case and is provided with a first positioning portion at the first inner wall. The second case has a second inner wall opposite to the first case and is provided with a second positioning portion at the second inner wall. The battery module has two ends that are inserted into the first positioning portion and the second positioning portion, respectively. The inverter is disposed in the shell and electrically connected to the battery module.

### CROSS-REFERENCE TO RELATED APPLICATION

This application claims priorities to Chinese Patent Application No. 202411709371.7, filed on Nov. 25, 2024, Chinese Patent Application No. 202510080365.8, filed on Jan. 16, 2025, Chinese Patent Application No. 202410895892.X, filed on Jul. 4, 2024, Chinese Patent Application No. 202421581438.9, filed on Jul. 4, 2024, all of which are hereby incorporated by reference in their entireties.

### FIELD

The present disclosure relates to the field of energy storage technologies, and in particular, to an energy storage power supply.

### BACKGROUND

In the related art, for an energy storage power supply, a battery pack is typically formed by fixing a plurality of cells using a bracket, and is then mounted in a shell. This approach results in a large number of spare parts, a large volume, high costs, and a complex mounting process of the energy storage power supply. On the other hand, in the shell of the energy storage power supply, since a mounting space needs to be reserved for the battery pack and other components such as an inverter, the volume of the energy storage power supply is further increased.

### SUMMARY

The present disclosure aims to solve at least one of the technical problems in the prior art or the related art.

To this end, the present disclosure provides an energy storage power supply. The energy storage power supply includes: a shell including a first case and a second case detachably connected to the first case, the first case having a first inner wall opposite to the second case and being provided with a first positioning portion at the first inner wall, and the second case having a second inner wall opposite to the first case and being provided with a second positioning portion at the second inner wall; a battery module having two ends that are inserted into the first positioning portion and the second positioning portion, respectively; and an inverter disposed in the shell and electrically connected to the battery module.

With the energy storage power supply provided in the present disclosure, the first positioning portion is disposed at the first case and the second positioning portion is disposed at the second case. Therefore, the first case and the second case can replace a bracket commonly used for a battery in the related art, which effectively reduces a quantity of components in the energy storage power supply. In this way, manufacturing costs and assembly difficulty are conducive to being reduced. In addition, an improvement in utilization of an internal space within the energy storage power supply can be facilitated, which is beneficial for miniaturization of the energy storage power supply.

The present disclosure provides an energy storage power supply. The energy storage power supply includes: a shell including a first case and a second case detachably connected to the first case, the first case having a first inner wall opposite to the second case and being provided with a first positioning portion at the first inner wall, and the second case having a second inner wall opposite to the first case; a plurality of cells, each of the plurality of cells having one end inserted into the first positioning portion and another end abutting with the second inner wall to allow the plurality of cells to be fixed to the first positioning portion; and an inverter disposed in the shell and electrically connected to the plurality of cells.

The energy storage power supply provided in the present disclosure eliminates the bracket used for fixing cells in a conventional energy storage power supply. Instead, the first positioning portion and the second positioning portion are utilized to fix the plurality of cells, which effectively reduces the quantity of components in the shell. In this way, the manufacturing costs and the assembly difficulty are conducive to being reduced. In addition, the improvement in the utilization of the internal space within the energy storage power supply can be facilitated, which is beneficial for the miniaturization of the energy storage power supply.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a cross-sectional view of an energy storage power supply according to an implementation of a first embodiment of the present disclosure.

FIG. 2 is an exploded view of an energy storage power supply according to an implementation of a first embodiment of the present disclosure.

FIG. 3 is a schematic structural view of a bottom housing of an energy storage power supply according to an implementation of a first embodiment of the present disclosure.

FIG. 4 is a schematic structural view of a top housing of an energy storage power supply according to an implementation of a first embodiment of the present disclosure.

FIG. 5 is a schematic structural view of a battery module of an energy storage power supply according to an implementation of a first embodiment of the present disclosure.

FIG. 6 is an exploded view of an energy storage power supply according to another implementation of a first embodiment of the present disclosure.

FIG. 7 is a schematic structural view of a cell of a battery module of an energy storage power supply according to another implementation of a first embodiment of the present disclosure.

FIG. 8 is a schematic structural view of a first battery module of an energy storage power supply according to another implementation of a first embodiment of the present disclosure.

FIG. 9 is a schematic structural view of a first bracket of an energy storage power supply according to another implementation of a first embodiment of the present disclosure.

FIG. 10 is a schematic structural view of a second bracket of an energy storage power supply according to another implementation of a first embodiment of the present disclosure.

FIG. 11 is a cross-sectional view of an energy storage power supply according to a second embodiment of the present disclosure.

FIG. 12 is a schematic structural view of an energy storage power supply according to a second embodiment of the present disclosure.

FIG. 13 is a schematic assembled view of an energy storage power supply according to a second embodiment of the present disclosure.

FIG. 14 is a schematic structural view of a first case of a shell according to a second embodiment of the present disclosure.

FIG. 15 is a schematic structural view of a first case of a shell according to a second embodiment of the present disclosure, viewed from another perspective.

FIG. 16 is a schematic structural view of a second case of a shell according to a second embodiment of the present disclosure.

FIG. 17 is a schematic assembled view of another energy storage power supply according to a second embodiment of the present disclosure.

FIG. 18 is a schematic structural view of a second case of a shell according to a second embodiment of the present disclosure, viewed from another perspective.

FIG. 19 is a schematic structural view of an energy storage power supply according to a third embodiment of the of the present disclosure.

FIG. 20 is a schematic exploded view of an energy storage power supply according to a third embodiment of the present disclosure.

FIG. 21 is a schematic structural view of a cell according to a third embodiment of the present disclosure.

FIG. 22 is a schematic structural view of a first case according to a third embodiment of the present disclosure.

FIG. 23 is a schematic structural view of an energy storage power supply according to a third embodiment of the present disclosure.

FIG. 24 is a schematic structural view of a second case according to a third embodiment of the present disclosure.

FIG. 25 is a schematic structural view of an energy storage power supply according to a third embodiment of the present disclosure.

FIG. 26 is a schematic structural view of an energy storage power supply according to a third embodiment of the present disclosure.

FIG. 27 is a schematic structural view of a first case according to a third embodiment of the present disclosure.

FIG. 28 is a schematic structural view of an energy storage power supply according to a third embodiment of the present disclosure.

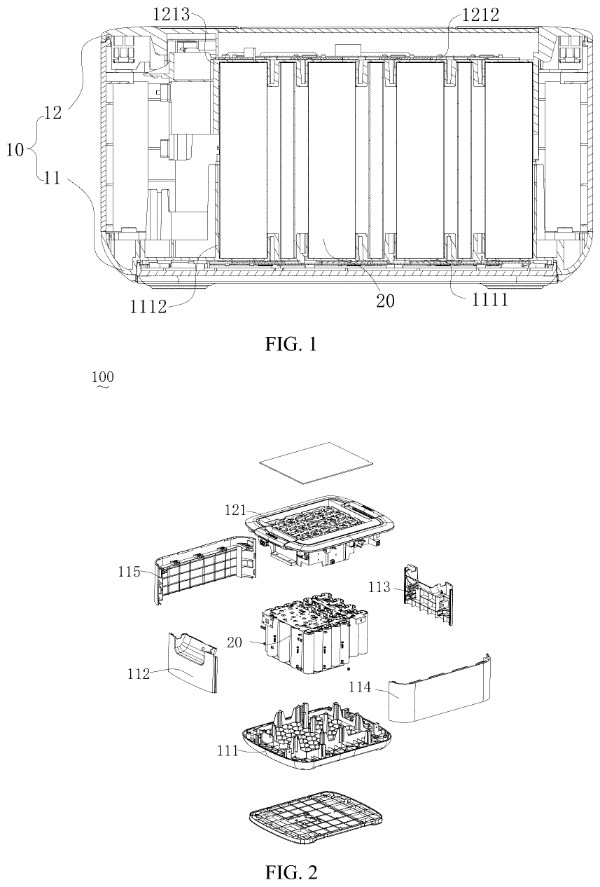

Correspondences between reference numerals in FIG. 1 to FIG. 10 and component names are as follows:

energy storage power supply 100, shell 10, first case 11, bottom housing 111, first inner wall 1111, inner bottom wall 11111, first positioning portion 1112, first positioning recess 11121, first connection post 1113, left side cover 112, right side cover 113, front side cover 114, rear side cover 115, second case 12, top housing 121, handle 1211, second inner wall 1212, inner top wall 12121, second positioning portion 1213, second positioning recess 12131, second connection post 1214, battery module 20, cell 21, electrode 211, connection member 22, first battery module 23, second battery module 24, first electrical connector 41, first bracket 42, third positioning portion 43, second bracket 44, fourth positioning portion 45, second electrical connector 46.

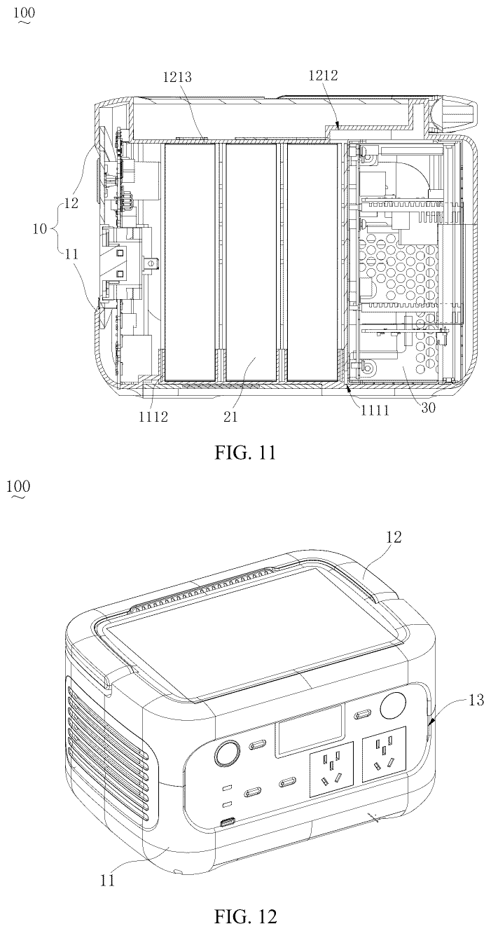

Correspondences between reference numerals in FIG. 11 to FIG. 18 and component names are as follows:

energy storage power supply 100, shell 10, first case 11, first inner wall 1111, first positioning portion 1112, first positioning recess 11121, first connection post 1113, first through hole 1114, support portion 116, first accommodation recess 117, first cover plate 118, second case 12, handle 1211, second inner wall 1212, second positioning portion 1213, second connection post 1214, second through hole 1215, second accommodation recess 124, second cover plate 125, opening 13, cell 21, electrode 211, inverter 30, substrate 31, electrical connector 40, first electrical connector 41, second electrical connector 42, battery management system 50, panel 60, mainboard 70.

Correspondences between reference numerals in FIG. 19 to FIG. 28 and component names are as follows:

energy storage power supply 100; shell 10; first case 11; first positioning portion 1112; second case 12; handle 1211; second positioning portion 1213; through hole 14; first aperture 141; second aperture 142; mounting hole 143; insertion recess 15; cell 21; positive electrode 25; negative electrode 26; first end 27; second end 28; inverter 30; electrical connector 40; battery management system 50; panel 60; accommodation cavity 61; mainboard 70; cover plate 80; decorative cover 90; vent 91.

### DETAILED DESCRIPTION

In order to clarify and explain the above objectives, features, and advantages of the present disclosure, the present disclosure will be further described in detail below in conjunction with the accompanying drawings and specific embodiments. It should be noted that, the embodiments of the present disclosure and features in the embodiments can be combined with each other without any conflict.

In the following description, many specific details are provided to facilitate full understanding of the present disclosure. However, the present disclosure can further be implemented in other ways different from those described herein. Therefore, the scope of protection of the present disclosure is not limited by specific embodiments disclosed below.

First embodiment is described below.

An energy storage power supply 100 according to some embodiments of the present disclosure will be described below with reference to FIG. 1 to FIG. 10.

Referring to FIG. 1, the energy storage power supply 100 according to the embodiments of the present disclosure includes a shell 10 and a battery module 20. The shell 10 includes a first case 11 and a second case 12. The first case 11 is detachably connected to the second case 12. The first case 11 has a first inner wall 1111 opposite to the second case 12 and is provided with a first positioning portion 1112 at the first inner wall 1111. The second case 12 has a second inner wall 1212 opposite to the first case 11 and is provided with a second positioning portion 1213 at the second inner wall 1212. The battery module 20 has two ends that are inserted into the first positioning portion 1112 and the second positioning portion 1213, respectively.

With the energy storage power supply 100 provided in the present disclosure, the first positioning portion 1112 is disposed at the first case 11 and the second positioning portion 1213 is disposed at the second case 12. Therefore, the first case 11 and the second case 12 can replace a bracket commonly used for a battery in the related art, which effectively reduces a quantity of components in the energy storage power supply 100. In this way, manufacturing costs and assembly difficulty are conducive to being reduced. In addition, an improvement in utilization of an internal space within the energy storage power supply 100 can be facilitated, which is beneficial for miniaturization of the energy storage power supply 100.

Specifically, the energy storage power supply 100 is a device capable of storing electrical energy and releasing the electrical energy when needed. A main function of the energy storage power supply 100 is to provide stable and reliable power supply. When a system needs to store electrical energy, a controller charges a battery group, and the battery group converts the electrical energy into chemical energy for storage. When the system needs to use the electrical energy, the controller converts direct-current electrical energy stored in the battery group into alternating-current electrical energy, and then outputs the alternating-current electrical energy.

In the embodiments of the present disclosure, an accommodation cavity is defined by the first case 11 and the second case 12, and the battery module 20 is disposed in the accommodation cavity.

Referring to FIG. 2, in some embodiments, the first case 11 includes a bottom housing 111, the first inner wall 1111 includes an inner bottom wall 11111 of the shell 10, the second case 12 includes a top housing 121, and the second inner wall 1212 includes an inner top wall 12121 of the shell 10.

In this way, the first case 11 and the second case 12 can be separately processed and formed, which is conducive to reducing processing difficulty.

Specifically, in the embodiments of the present disclosure, the first case 11 includes a bottom housing 111, a left side cover 112, a right side cover 113, a front side cover 114, and a rear side cover 115. The first inner wall 1111 includes the inner bottom wall 11111 of the shell 10. The inner bottom wall 11111 is formed at the bottom housing 111. The first positioning portion 1112 is disposed at the inner bottom wall 11111. The second case 12 includes a top housing 121. The second inner wall 1212 includes the inner top wall 12121 of the shell 10. The inner top wall 12121 is disposed at the top housing 121. The second positioning portion 1213 is disposed at the inner top wall 12121.

In other embodiments, the left side cover 112, the right side cover 113, the front side cover 114, and the rear side cover 115 may partially or entirely be part of the top housing 121.

In other embodiments, the first positioning portion 1112 may be disposed at a part of the first inner wall 1111 other than the inner bottom wall 11111, and the inner bottom wall 11111 may also be disposed at a part of the first case 11 other than the bottom housing 111. Similarly, the second positioning portion 1213 may be disposed at a part of the second inner wall 1212 other than the inner top wall 12121, and the inner top wall 12121 may also be disposed at a part of the second case 12 other than the top housing 121. Specific arrangements can be made as desired and are not limited here.

In the embodiments of the present disclosure, the top housing 121, the bottom housing 111, the left side cover 112, the right side cover 113, the front side cover 114, and the rear side cover 115 each have an integral structure formed through integral injection molding, and are then connected by fasteners or other connection methods.

In other embodiments, the shell 10 may also be split into any parts as desired. Each part may have an integral structure formed through integral processing and molding or manufactured using other processing methods.

Further, the accommodation cavity is defined by the top housing 121, the bottom housing 111, the left side cover 112, the right side cover 113, the front side cover 114, and the rear side cover 115. The battery module 20 is disposed in the accommodation cavity.

In some embodiments, the battery module 20 has one end fixed at the top housing 121 and another end fixed at the bottom housing 111.

In other embodiments, the battery module 20 has two ends that may be respectively fixed at the left side cover 112 and the right side cover 113, or respectively fixed at the front side cover 114 and the rear side cover 115. A specific choice can be made as desired, and thus the present disclosure is not limited in this regard.

In the embodiments of the present disclosure, the top housing 121 is provided with two handles 1211. The handle 1211 is used for moving or carrying the energy storage power supply 100.

Further, two avoidance recesses are formed at the top housing 121 and arranged corresponding to a left side plate and a right side plate, respectively. The handle 1211 extends through the avoidance recess and is exposed outside the shell 10.

In some embodiments, the handle 1211 is made of a metallic material. Specifically, the handle 1211 may be made of an aluminum alloy and is hollow internally, which facilitates a lightweight design of the energy storage power supply 100. In addition, the handle 1211 made of the aluminum alloy also offers high strength and durability, which is conducive to enhancing reliability of the handle 1211 and prolonging a service life of the handle 1211.

In other embodiments, the two avoidance recesses may also be arranged corresponding to a front side plate and a rear side plate, respectively.

In other embodiments, the handle 1211 may also be made of other materials. A specific choice can be made as desired and is not limited in this regard.

In other embodiments, the handle 1211 may also be designed as a flexible handle, offering satisfactory adaptability and flexibility, along with improved comfort and tactile feel.

In the embodiments of the present disclosure, the bottom housing 111 is further provided with a support portion at a side of the bottom housing 111 away from the battery module 20. The support portion is provided with an anti-slip structure. Alternatively, the anti-slip structure may be an anti-slip silicone pad, an anti-slip rubber pad, or an anti-slip pattern formed at the support portion.

In other embodiments, the bottom housing 111 may also have a fixing recess at a side of the bottom housing 111 away from the battery module 20. A relatively thick anti-slip pad is disposed in the fixing recess. A material of the anti-slip pad can be selected as desired and is not limited here.

In the embodiments of the present disclosure, the energy storage power supply 100 further includes an expansion socket, a socket device designed to address insufficient numbers of power outlets. The expansion socket is disposed at each of the left side plate and the right side plate.

In other embodiments, the expansion socket may also be disposed at at least one of the top housing 121, the bottom housing 111, the left side cover 112, the right side cover 113, the front side cover 114. The rear side cover 115. A specific choice can be made as desired and is not limited here.

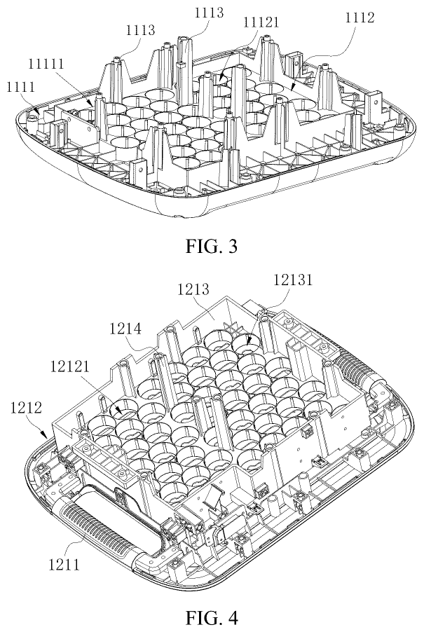

Referring to FIG. 3 and FIG. 4, in some embodiments, the first positioning portion 1112 has a plurality of first positioning recesses 11121, and the second positioning portion 1213 has a plurality of second positioning recesses 12131 corresponding to the plurality of first positioning recesses 11121, respectively.

In this way, each of the first positioning recess 11121 and the second positioning recess 12131 is used to fix the battery module 20.

Specifically, the first positioning recess 11121 is formed at the first inner wall 1111 of the bottom housing 111, and the second positioning recess 12131 is formed at the second inner wall 1212 of the top housing 121.

Further, a plurality of first positioning recesses 11121 are formed and arranged in an array, and a plurality of second positioning recesses 12131 are formed and arranged in an array. The plurality of second positioning recesses 12131 correspond to the plurality of first positioning recesses 11121 in one-to-one correspondence. In this embodiment, the battery module 20 includes a plurality of cells 21 arranged in an array, and one second positioning recess 12131 cooperates with one first positioning recess 11121 to fix one cell 21 of the battery module 20.

Referring to FIG. 1 to FIG. 4, in some embodiments, the first case 11 includes a plurality of first connection posts 1113, and the second case 12 includes a plurality of second connection posts 1214. The plurality of first connection posts 1113 are connected to the plurality of second connection posts 1214 when the first case 11 is connected to the second case 12.

In this way, the first connection post 1113 and the second connection post 1214 are used for connecting the first case 11 and the second case 12. Additionally, the first connection post 1113 helps enhance structural strength of the first case 11, and the second connection post 1214 helps enhance structural strength of the second case 12.

In some embodiments, the plurality of first connection posts 1113 are disposed at the first inner wall 1111 of the bottom housing 111 and arranged in an array of multiple rows and multiple columns. The first positioning recesses 11121 are defined between two adjacent rows and two adjacent columns of first connection posts 1113. An array arrangement of the plurality of first connection posts 1113 enables the first positioning recesses 11121 to be spaced apart from each other.

Similarly, the plurality of second connection posts 1214 are disposed at the second inner wall 1212 of the top housing 121 and arranged in an array of multiple rows and multiple columns. The second positioning recesses 12131 are defined between two adjacent rows and two adjacent columns of second connection posts 1214. An array arrangement of the plurality of second connection posts 1214 enables the second positioning recesses 12131 to be spaced apart from each other.

Further, the first connection post 1113 and the bottom housing 111 have an integral structure formed through integral processing and molding, and the second connection post 1214 and the top housing 121 have an integral structure formed through integral processing and molding.

It should be understood that, by arranging the first positioning recesses 11121 and the second positioning recesses 12131 at intervals through the plurality of first connection posts 1113 and the plurality of second connection posts 1214, the plurality of cells 21 can be ensured to be arranged at intervals, which can reduce issues such as a thermal expansion caused by direct contact among the plurality of cells 21, and reduce occurrences of the plurality of cells 21 being compressed and deformed due to an impact on the energy storage power supply 100. In this way, a safety risk is lowered.

In some embodiments, cylindrical first positioning recesses 11121 and cylindrical second positioning recesses 12131 may be respectively defined between two adjacent rows and two adjacent columns of first connection posts 1113 and between two adjacent rows and two adjacent columns of second connection posts 1214, which can ensure stable placement of cylindrical cells 21, improving stability of the cylindrical cells 21.

Specifically, an outer peripheral wall of each first connection post 1113 and an outer peripheral wall of each second connection post 1214 are formed as arc-shaped surfaces to define the cylindrical first positioning recess 11121 and the cylindrical second positioning recess 12131, in such a manner that an outer peripheral wall of a cylindrical recess matches an outer peripheral wall of the cell 21, further ensuring a connection effect between the cell 21 and the positioning portion to reduce occurrences of shaking.

In other embodiments, each of the first positioning recess 11121 and the second positioning recess 12131 may be also in other shapes, e.g., a rectangular shape, to ensure stable placement of cells 21 in different shapes. No specific limitation is imposed here.

In some embodiments, since each of the first connection post 1113 and the second connection post 1214 is relatively long, the bottom housing 111 is further provided with a first reinforcing rib to enhance structural strength of each of the first connection post 1113 and the second connection post 1214. The first reinforcing rib is triangular or trapezoidal in shape. The first reinforcing rib has one end connected to the first inner wall 1111 and another end connected to the first connection post 1113. Similarly, the top housing 121 is further provided with a second reinforcing rib. The second reinforcing rib is triangular or trapezoidal in shape. The second reinforcing rib has one end connected to the second inner wall 1212 and another end connected to the second connection post 1214.

Further, each first connection post 1113 is connected to a plurality of first reinforcing ribs. Similarly, each second connection post 1214 is connected to a plurality of second reinforcing ribs. In the embodiments of the present disclosure, each first connection post 1113 is connected to at least three first reinforcing ribs, and similarly, each second connection post 1214 is connected to at least three second reinforcing ribs.

Further, to further enhance the structural strength of the first connection post 1113, the first reinforcing ribs between two adjacent first connection posts 1113 located at an outer side of the battery module 20 are connected to each other. Similarly, the second reinforcing ribs between two adjacent second connection posts 1214 located at the outer side of the battery module 20 are also connected to each other.

In some embodiments, the shell 10 includes a plurality of fasteners. The plurality of fasteners are securely connected to corresponding first connection posts 1113 and corresponding second connection posts 1214, respectively, to allow the first case 11 to be connected to the second case 12.

In this way, using the fasteners to achieve a detachable connection between the first connection post 1113 and the second connection post 1214 facilitates reducing maintenance difficulty of the energy storage power supply 100.

Specifically, in the embodiments of the present disclosure, the first connection post 1113 at the bottom housing 111 extends towards the top housing 121 in a height direction of the energy storage power supply 100, and the second connection post 1214 at the top housing 121 extends towards the bottom housing 111 in the height direction of energy storage power supply 100. The first connection post 1113 and the second connection post 1214 each are hollow internally, and have threaded holes at ends of the first connection post 1113 and the second connection post 1214 that are opposite to each other. An interior of the second connection post 1214 contains a fastener that can be screwed into the threaded hole. In addition, the detachable connection between the first connection post 1113 and the second connection post 1214 is achieved through a threaded connection.

In other embodiments, the fastener that can be screwed into the threaded hole may also be disposed in the first connection post 1113.

In other embodiments, the first connection post 1113 and the second connection post 1214 may also be detachably connected to each other by means of a snap, a pin, or the like.

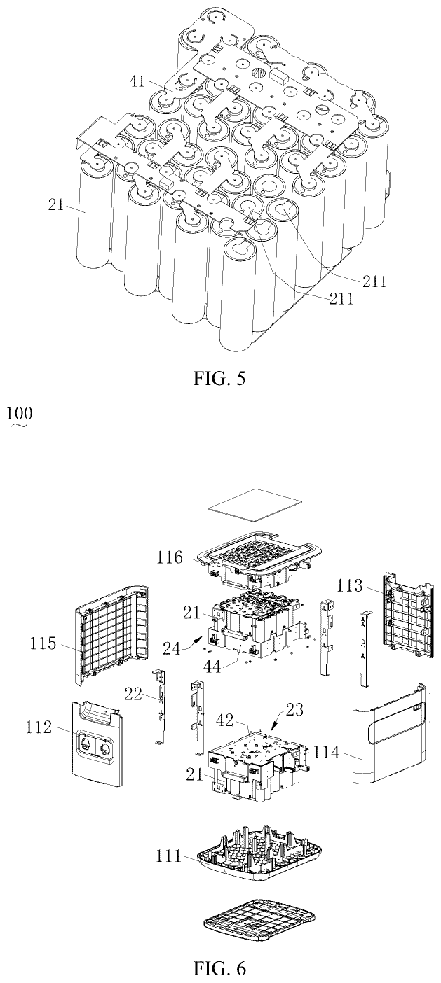

Referring to FIG. 1 and FIG. 5, in some embodiments, the battery module 20 includes a single layer of cells 21. The cell 21 has two ends that are inserted into the first positioning portion 1112 and the second positioning portion 1213, respectively.

In this way, the battery module 20 including the single layer of cells 21 can be fixed by the first positioning portion 1112 and the second positioning portion 1213, which completely eliminates a need for the bracket in the battery. In this way, the manufacturing costs and the assembly difficulty are conducive to being reduced.

Specifically, one of the two ends of the cell 21 is inserted into the first positioning recess 11121 of the first positioning portion 1112, and another of the two ends of the cell 21 is disposed in the second positioning recess 12131 of the second positioning portion 1213. A cooperation between the first positioning recess 11121 and the second positioning recess 12131 enables fixation of the cell 21.

In some embodiments, the cell 21 may be sheet-shaped or square-shaped. Correspondingly, each of the first positioning recess 11121 and the second positioning recess 12131 should be configured as a square recess matching the cell 21, ensuring the stability of the cell 21.

In another example, the cell 21 may also be cylindrical in shape. Correspondingly, each of the first positioning recess 11121 and the second positioning recess 12131 should be configured as a circular recess matching the cell 21 to ensure the stability of the cell 21.

In other examples, the cell 21 may also take other shapes. Correspondingly, each of the first positioning recess 11121 and the second positioning recess 12131 should be configured as a recess matching the cell 21, ensuring stable placement of the cell 21. No specific limitation is imposed here.

Referring to FIG. 5, in some embodiments, the cell 21 includes two electrodes 211 located at two ends of the cell 21, respectively. The energy storage power supply 100 further includes a first electrical connector 41. The first electrical connector 41 is disposed at the first positioning portion 1112 and the second positioning portion 1213 to connect electrodes 211 multiple adjacent cells 21 at one side of the multiple adjacent cells 21.

By disposing the first electrical connector 41 at the first positioning portion 1112 and the second positioning portion 1213, the improvement in the utilization of the internal space within the energy storage power supply 100 can be facilitated,

Specifically, the first electrical connector 41 can connect a positive electrode post and a negative electrode post of at least one cell 21 alternately, in such a manner that the positive electrode post and the negative electrode post that are connected to two ends of the first electrical connector 41 serve as a positive wiring port and a negative wiring port, respectively. That is, the first electrical connector 41 is connected to the at least one cell 21 in series, allowing the at least one cell 21 to form an output power source having a high voltage, ensuring electricity needs of a user to be satisfied.

Further, each of the first positioning recess 11121 and the second positioning recess 12131 has a through hole at a bottom of each of the first positioning recess 11121 and the second positioning recess 12131. The electrode 311 of the cell 21 is connected to the first electrical connector 41 after passing through the through hole.

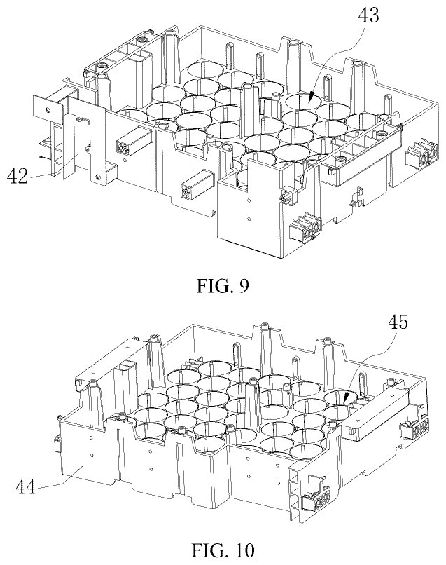

Referring to FIG. 6, FIG. 9, and FIG. 10, in some embodiments, the battery module 20 includes a first battery module 23 and a second battery module 24 stacked together.

The first battery module 23 includes a first bracket 42 connected to the first case 11 and several cells 21 of the plurality of cells 21. The first bracket 42 is provided with a third positioning portion 43. Each of the several cells 21 of the first battery module 23 has two ends that are inserted into the first positioning portion 1112 and the third positioning portion 43, respectively.

In this way, the first bracket 42 serves to assist in fixing the first battery module 23, avoiding instability caused by lack of support between the first battery module 23 and the second battery module 24 that are stacked on each other.

In some embodiments, the second battery module 24 includes a second bracket 44 connected to the second case 12 and several cells 21 of the plurality of cells 21. The second bracket 44 is provided with a fourth positioning portion 45. Each of the several cells 21 of the second battery module 24 has two ends that are inserted into the second positioning portion 1213 and the fourth positioning portion 45, respectively.

Specifically, in some embodiments, each of the first battery module 23 and the second battery module 24 includes a plurality of cells 21. The plurality of cells 21 are arranged in an upright array. That is, a length direction of the cell 21 is set in a vertical direction to ensure minimal space occupation.

In other embodiments, the plurality of cells 21 may also be arranged in an array in other directions as desired.

In other embodiments, each of the first battery module 23 and the second battery module 24 may also be placed in other ways as desired.

Referring to FIG. 8, in some embodiments, the energy storage power supply 100 further includes a second electrical connector 46. The second electrical connector 46 is disposed at the first bracket 42 and the second bracket 44 to connect electrodes 211 of multiple adjacent cells 21 at one side of the multiple adjacent cells 21.

Specifically, the second electrical connector 46 can connect the positive electrode post and the negative electrode post of at least one cell 21 alternately, in such a manner that the positive electrode post and the negative electrode post that are connected to two ends of the second electrical connector 46 serve as the positive wiring port and the negative wiring port, respectively. That is, the second electrical connector 46 is connected to the at least one cell 21 in series, allowing the at least one cell 21 to form an output power source having a high voltage, ensuring the electricity needs of the user to be satisfied.

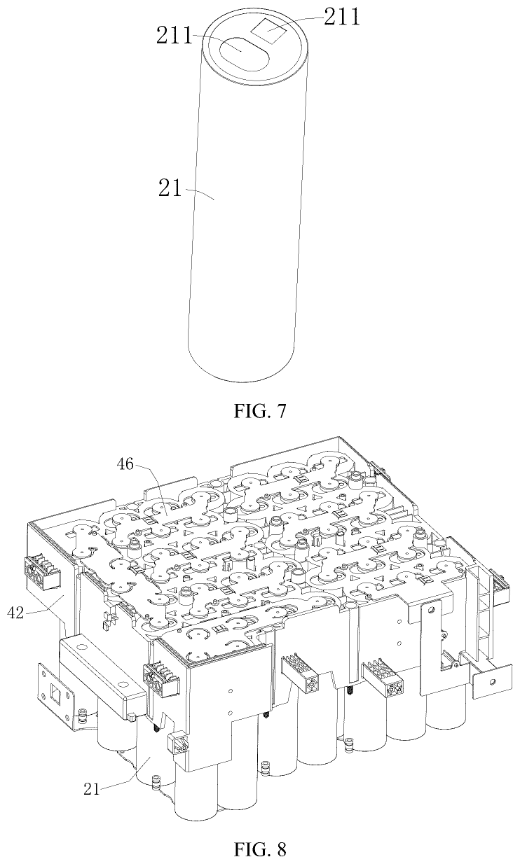

Referring to FIG. 7, in some embodiments, the cell 21 is provided with two electrodes 211 at a first end of the cell 21.

In this way, the electrodes 211 of two layers of cells 21 can be arranged at intervals, avoiding short circuits due to accidental contact between the electrodes 211 of the two layers of cells.

Specifically, in some embodiments, the cell 21 has two electrodes 211 that are disposed at one side of the cell 21. When arrayed, the electrodes 211 should be concentrated at one side of the energy storage power supply for a convenient connection between the cells 21.

Further, since the first end of the cell 21 of the first battery module 23 is inserted into the first positioning portion 1112, and the first end of the cell 21 of the second battery module 24 is inserted into the second positioning portion 1213, the electrodes 211 of the cell 21 of the first battery module 23 are arranged opposite to the electrodes 211 of the cell 21 of the second battery module 24.

Further, since the electrodes 211 of the cell 21 of the first battery module 23 are arranged opposite to the electrodes 211 of the cell 21 of the second battery module 24, an insulating layer needs to be provided between two energy storage power supplies to avoid short circuits or other problems in the energy storage power supply due to an unintended connection between the cells 21 of the upper energy storage power supply and the lower energy storage power supply.

In some embodiments, the cell 21 of the first battery module 23 has a second end that may also be inserted into the first positioning portion 1112, and the cell 21 of the second battery module 24 has a second end that may also be inserted into the second positioning portion 1213. Since the electrodes 211 are concentrated at the one side of the energy storage power supply, the electrodes 211 of the two energy storage power supplies are arranged away from each other when the two energy storage power supplies are stacked in this manner, which can eliminate a need for the insulating layer between the two energy storage power supplies, reducing the manufacturing costs and the assembly difficulty.

In some embodiments, the cell 21 has two electrodes 211 that may also be disposed at two opposite sides of the cell 21, respectively. When arrayed, the electrodes 211 are concentrated at two sides of the energy storage power supply for a convenient connection between the cells 21.

Further, since the electrodes 211 are concentrated at the two sides of the energy storage power supply, the insulating layer needs to be provided between the two energy storage power supplies when the two energy storage power supplies are stacked in the vertical direction, to avoid short circuits or other problems in the energy storage power supply due to the unintended connection between the cells 21 of the upper energy storage power supply and the lower energy storage power supply.

Referring to FIG. 6, in some embodiments, the battery module 20 further includes a connection member 22 configured to connect the first battery module 23 and the second battery module 24.

In this way, the first battery module 23 and the second battery module 24 are fixedly connected by the connection member 22, which is conducive to assembling the battery module 20. In this way, the assembly difficulty of the energy storage power supply 100 are conducive to being reduced.

Specifically, the connection member 22 is a sheet metal part. The sheet metal part refers to a metallic product processed through a specific sheet metal technique. This technique mainly targets thin metallic sheets (usually below 6 mm), including a series of comprehensive cold working processes such as shearing, punching/cutting/compositing, bending, welding, riveting, splicing, forming, etc. A notable feature of the sheet metal part is that a thickness remains consistent within one part. The sheet metal part has characteristics such as lightweight design, high strength, satisfactory electrical conductivity (usable for electromagnetic shielding), low costs, and suitability for mass production.

In this way, the sheet metal part generally has high tensile strength and compressive strength, which helps prolong a service life of the connection member 22. In addition, the sheet metal part can be processed with a high efficiency, which is beneficial for shortening a processing cycle.

In the embodiments of the present disclosure, the connection member 22 is formed through shearing, cutting, and bending. In this way, any burrs that may occur during the processing are removed. Further, sharp corners of the connection member 22 are rounded off to prevent injury to hands of an operator during assembly or maintenance.

In other embodiments, the connection member 22 may also be formed through other sheet metal processes, such as one-time stamping. A specific sheet metal process can be chosen as desired and is not limited here.

In some embodiments, the connection member 22 is made of a galvanized plate.

In this way, the galvanized plate has high strength and durability, which helps prolong the service life of the connection member 22.

Specifically, the galvanized plate refers to a steel plate coated with a layer of a metal zinc on a surface of the steel plate to prevent corrosion of the surface of the steel plate and prolong a service life of the steel plate.

In the embodiments of the present disclosure, the connection member 22 is processed from the galvanized plate using the sheet metal technique. It should be noted that, before a sheet metal processing is performed on the galvanized plate, the surface of the galvanized plate needs to be ensured to be clean, free of oil stains, rust, and impurities. These impurities are likely to affect a processing accuracy and a product quality. Additionally, whether a galvanized layer is uniform and there is peeling need to be checked. An uneven galvanized layer is likely to affect anti-corrosion performance and an appearance of a product.

When the sheet metal processing is performed on the galvanized plate, cutting marks produced during the punching should comply with safety requirements (not cutting hands) and requirements of dimensional tolerances of parts, generally no more than 10% to 20% of a thickness of the plate. A depth of the cutting marks produced during the bending should be controlled within 0.3 mm.

In other embodiments, the connection member 22 may also be made of other metallic materials through the sheet metal technique. A specific metallic material can be selected as desire and is not limited here.

Second embodiment is described below.

The energy storage power supply 100 according to some embodiments of the present disclosure will be described below with reference to FIG. 11 to FIG. 18.

Referring to FIG. 11, the energy storage power supply 100 according to the embodiments of the present disclosure includes the shell 10, the plurality of cells 21, and an inverter 30. The shell 10 includes the first case 11 and the second case 12. The first case 11 is detachably connected to the second case 12. The first case 11 has the first inner wall 1111 opposite to the second case 12 and is provided with the first positioning portion 1112 at the first inner wall 1111. The second case 12 has the second inner wall 1212 opposite to the first case 11. Each of the plurality of cells 21 has one end inserted into the first positioning portion 1112 and another end abutting with the second inner wall 1212 to allow the plurality of cells 21 to be fixed to the first positioning portion 1112. The inverter 30 is disposed in the shell 10 and electrically connected to the plurality of cells 21.

The energy storage power supply 100 provided in the present disclosure eliminates the bracket used for fixing cells 21 in a conventional energy storage power supply 100. Instead, the first case 11 and the second case 12 are utilized to fix the plurality of cells 21, which effectively reduces the quantity of components in the shell 10. In this way, the manufacturing costs and the assembly difficulty are conducive to being reduced. In addition, the improvement in the utilization of the internal space within the energy storage power supply 100 can be facilitated, which is beneficial for the miniaturization of the energy storage power supply 100.

Specifically, referring to FIG. 12, the energy storage power supply 100 is a device capable of storing electrical energy and releasing the electrical energy when needed. A main function of the energy storage power supply 100 is to provide stable and reliable power supply. When a system needs to store electrical energy, a controller charges a battery group, and the battery group converts the electrical energy into chemical energy for storage. When the system needs to use the electrical energy, the controller converts direct-current electrical energy stored in the battery group into alternating-current electrical energy, and then outputs the alternating-current electrical energy.

Referring to FIG. 11 to FIG. 13, in the embodiments of the present disclosure, the accommodation cavity is defined by the first case 11 and the second case 12, and the plurality of cells 21 are disposed in the accommodation cavity.

In some embodiments, the first case 11 is a lower bottom housing of the shell 10. The first inner wall 1111 is an inner bottom wall of the lower bottom housing. The second case 12 is an upper top housing of the shell 10. The second inner wall 1212 is an inner top wall of the upper top housing. The first case 11 and the second case 12 are separately processed and formed, and are detachably connected by a fastener. In this way, a reduction of the processing difficulty and the assembly difficulty can be facilitated.

In the embodiments of the present disclosure, the second case 12 is provided with the handle 1211. The handle 1211 is used for moving or carrying the energy storage power supply 100.

Further, the second case 12 has an avoidance recess at a top of the second case 12. The handle 1211 is rotatably disposed at the second case 12. The avoidance recess is configured to accommodate the handle 1211.

In some embodiments, the handle 1211 is made of the metallic material. Specifically, the handle 1211 may be made of the aluminum alloy and is hollow internally, which facilitates the lightweight design of the energy storage power supply 100. In addition, the handle 1211 made of the aluminum alloy also offers high strength and durability, which is conducive to enhancing the reliability of the handle 1211 and prolonging the service life of the handle 1211.

In other embodiments, the handle 1211 may also be made of other materials. A specific choice can be made as desired and is not limited here.

In other embodiments, the handle 1211 may also be designed as the flexible handle 1211, offering the satisfactory adaptability and flexibility, along with the improved comfort and tactile feel.

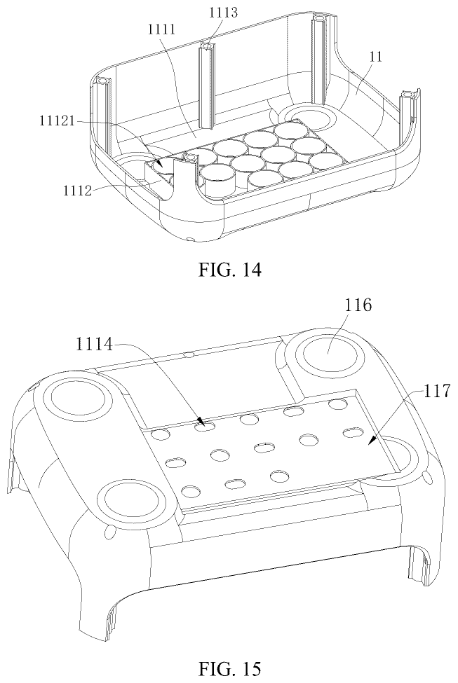

Referring to FIG. 14, in some embodiments, the first case 11 is further provided with a support portion 116 at a side of the first case 11 away from the plurality of cells 21. The support portion 116 is provided with an anti-slip structure. Alternatively, the anti-slip structure may be an anti-slip silicone pad, an anti-slip rubber pad, or an anti-slip pattern formed at the support portion 116.

In some embodiments, the first case 11 may also have a fixing recess at a side of the first case 11 away from the plurality of cells 21. A relatively thick anti-slip pad is disposed in the fixing recess. A material of the anti-slip pad can be selected as desired and is not limited here.

In some embodiments, the first positioning portion 1112 has a plurality of first positioning recesses 11121. Each of the plurality of cells 21 has one end inserted into the first positioning recess 11121. The second inner wall 1212 is provided with the second positioning portion 1213. The second positioning portion 1213 has a plurality of second positioning recesses. Each of the plurality of cells 21 has another end inserted into the second positioning recess.

In this way, each of the first positioning recess 11121 and the second positioning recess is used to fix the plurality of cells 21.

Specifically, referring to FIG. 15, the first positioning recess 11121 is formed at the first inner wall 1111 of the lower bottom housing. Further, a plurality of first positioning recesses 11121 are formed and arranged in an array. In this embodiment, the plurality of cells 21 are arranged in an array. One first positioning recess 11121 is used for fixing one cell 21 through a cooperation.

In some embodiments, the second positioning portion 1213 may be further disposed at the second inner wall 1212. Further, the second positioning portion 1213 has a plurality of second positioning recesses formed at the second inner wall 1212 of the upper top housing. The plurality of second positioning recesses are arranged in an array. The plurality of cells 21 are arranged in an array. One second positioning recess is used for fixing one cell 21 through a cooperation.

In some embodiments, to further fix the cell 21, a fixing adhesive may be injected into the first positioning recess 11121, making fixation of the cell 21 more secure and enhancing the stability of the cell 21. When the shell 10 of the energy storage power supply 100 experiences an impact or a vibration, the structural adhesive can absorb part of an impact force. Consequently, the impact experienced by the cell 21 can be reduced to prevent a leakage or even an explosion caused by an oscillation of an internal electrolyte due to an excessive impact on the cell 21. Preferably, the fixing adhesive may be a thermally conductive silicone gel having satisfactory thermal conductivity. In this way, the thermally conductive silicone gel can transfer and dissipate heat generated by the cell 21 during operation to the shell 10, which enables heat dissipation for the cell 21 to help reduce an operation temperature of the cell 21, avoiding a safety hazard caused by an excessively high temperature of the cell 21.

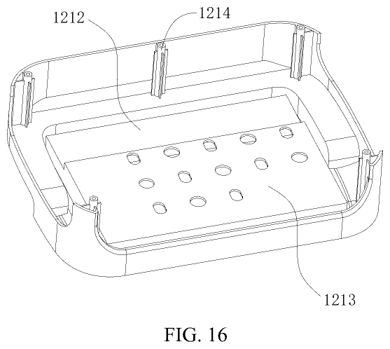

Referring to FIG. 14 and FIG. 16, in some embodiments, the first case 11 includes the plurality of first connection posts 1113, and the second case 12 includes a plurality of second connection posts 1214. The plurality of first connection posts 1113 are connected to the plurality of second connection posts 1214 when the first case 11 is connected to the second case 12.

In this way, arranging the first connection post 1113 and the second connection post 1214 facilitates a connection between the first case 11 and the second case 12.

Specifically, the first connection post 1113 is disposed at the first inner wall 1111 of the first case 11, and the second connection post 1214 is disposed at the second inner wall 1212 of the second case 12.

Further, the first connection post 1113 and the first case 11 have an integral structure formed through integral processing and molding, and the second connection post 1214 and the second case 12 have an integral structure formed through integral processing and molding.

Further, in the embodiments of the present disclosure, the first connection post 1113 and the second connection post 1214 are detachably connected by a fastener. The fastener includes a bolt mounted at the first connection post 1113 and a nut mounted at the second connection post 1214. The bolt is a hexagonal bolt, while the nut is a hexagonal nut.

Such a configuration can prevent a rotation of the bolt and the nut when the bolt and the nut are tightened together. In other embodiments, each of the bolt and the nut may be set in a quadrangular shape, an octagonal shape, or other shapes having non-circular cross sections to prevent the rotation of the bolt and the nut.

In some embodiments, the first connection post 1113 is disposed adjacent to a peripheral wall of the first case 11, and the second connection post 1214 is disposed adjacent to a peripheral wall of the second case 12.

Accordingly, by disposing each of the first connection post 1113 and the second connection post 1214 adjacent to the peripheral wall of the shell 10, the first connection post 1113 and the second connection post 1214 can be prevented from obstructing mounting of other components in the shell 10. In this way, utilization of an internal space within the shell 10 is facilitated.

Specifically, in the embodiments of the present disclosure, a plurality of first connection posts 1113 are provided and arranged at intervals and adjacent to the peripheral wall of the first case 11, and a plurality of second connection posts 1214 are provided and arranged at intervals and adjacent to the peripheral wall of the second case 12.

In some embodiments, since each of the first connection post 1113 and the second connection post 1214 is relatively long, the first connection post 1113 is further provided with a first reinforcing rib at a side surface of the first connection post 1113 to enhance the structural strength of the first connection post 1113 and the second connection post 1214. The first reinforcing rib has one end connected to the first inner wall 1111 and another end connected to the first connection post 1113. Similarly, the second connection post 1214 is further provided with a second reinforcing rib at a side surface of the second connection post 1214. The second reinforcing rib has one end connected to the second inner wall 1212 and another end connected to the second connection post 1214. It should be understood that, to reduce a weight of each of the first reinforcing rib and the second reinforcing rib, each of the first reinforcing rib and the second reinforcing rib may adopt other shapes, an opening may be formed at a surface of each of the first reinforcing rib and the second reinforcing rib, or a hollow structure may be selected for each of the first reinforcing rib and the second reinforcing rib.

Further, each first connection post 1113 is connected to a plurality of first reinforcing ribs. Similarly, each second connection post 1214 is connected to a plurality of second reinforcing ribs. In the embodiments of the present disclosure, each first connection post 1113 is connected to four first reinforcing ribs, and similarly, each second connection post 1214 is connected to four second reinforcing ribs.

Further, the first reinforcing rib disposed at the peripheral wall of the first connection post 1113 adjacent to the first case 11 is connected to the peripheral wall of the first case 11, and the second reinforcing rib disposed at the peripheral wall of the second connection post 1214 adjacent to the second case 12 is connected to the peripheral wall of the second case 12.

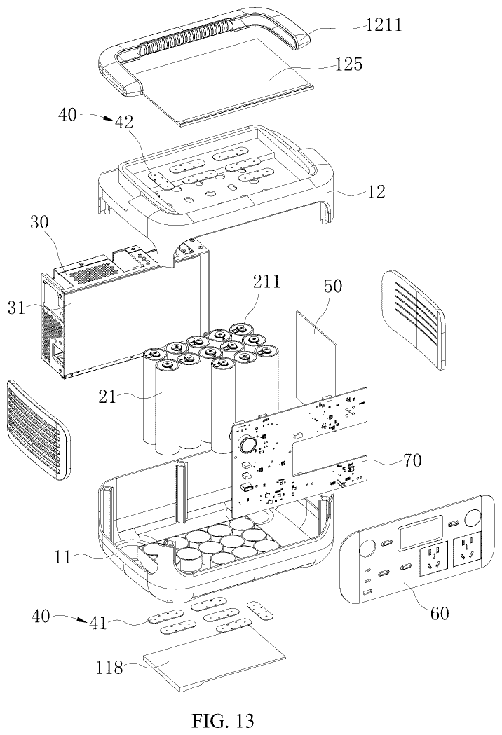

Referring to FIG. 13, in some embodiments, the energy storage power supply 100 further includes an electrical connector 40. The electrical connector 40 includes the first electrical connector 41 and the second electrical connector 42. The cell 21 has the positive electrode and the negative electrode that are located at two ends of the cell 21, respectively. The first electrical connector 41 is configured to electrically connect the positive electrode and/or the negative electrode at one end of each of the plurality of cells 21. The second electrical connector 42 is configured to electrically connect the positive electrode and/or the negative electrode at another end of each of the plurality of cells 21.

In this way, when the cell 21 includes two electrodes 211 arranged oppositely, the first electrical connector 41 and the second electrical connector 42 are used to connect the plurality of cells 21 in series or in parallel.

Specifically, in some embodiments, the cell 21 has the positive electrode and the negative electrode that are located at the two ends of the cell 21, respectively. Therefore, the electrical connector 40 should be disposed at each of the two ends of the cell 21.

Specifically, the electrode 211 of the cell 21 serves as a port for outputting or inputting electrical energy. Each cell 21 includes two electrodes 211: the positive electrode and the negative electrode. The two electrodes 211 are respectively disposed at two opposite sides of the cell 21, respectively. When arrayed, the electrodes 211 are concentrated at the two sides of the energy storage power supply 100 to facilitate connections between the cells 21.

Further, the first electrical connector 41 can connect the positive electrode and the negative electrode of at least one cell 21 alternately in sequence. That is, each first electrical connector 41 is connected to at least one cell 21 in series. Similarly, the second electrical connector 42 can also connect the positive electrode and the negative electrode of at least one cell 21 alternately in sequence. That is, each second electrical connector 42 is connected to at least one cell 21 in series.

In the embodiments of the present disclosure, the electrical connector 40 is a busbar. The electrical connector 40 may be made of copper, aluminum, nickel, or an alloy. After each of the first electrical connector 41 and the second electrical connector 42 is fixed to a correct position through a fixture or other means, the first electrical connector 41 or the second electrical connector 42 can be welded to the cell 21 through laser welding. It should be understood that other connection methods such as twisting or pressing can also achieve an electrical connection between the first electrical connector 41 or the second electrical connector 42 and the cell 21.

In some embodiments, the energy storage power supply 100 further includes the electrical connector 40. The cell 21 has the positive electrode and the negative electrode that are located at one end of the cell 21. The electrical connector 40 is configured to electrically connect the positive electrode of one cell 21 and the negative electrode of another cell 21.

In this way, when the cell 21 includes two electrodes 211 arranged at one end, the electrical connector 40 is used to connect the plurality of cells 21 in series or in parallel.

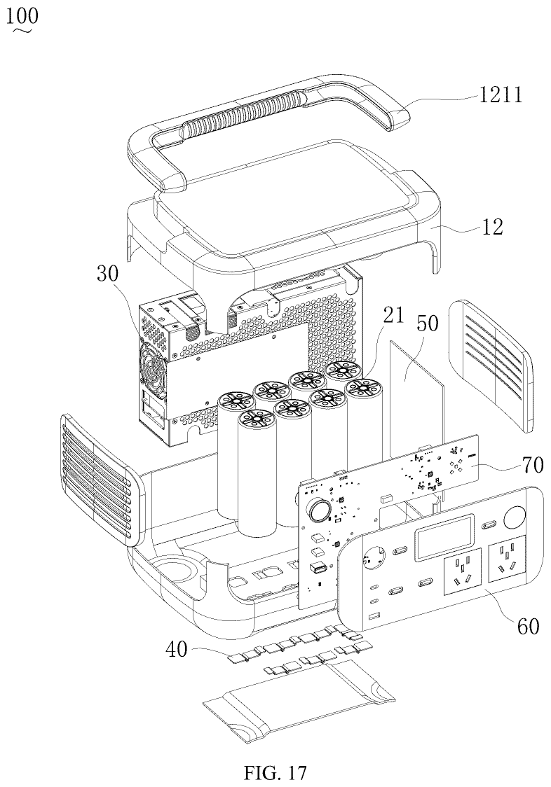

Specifically, referring to FIG. 17, in some embodiments, the cell 21 has the positive electrode and the negative electrode that are located below the cell 21. In this way, the electrical connector 40 only needs to be disposed at one end of the cell 21.

Referring to FIG. 14 and FIG. 16, in some embodiments, the electrical connector 40 is disposed at an outer side of the shell 10, and the through hole is formed at the shell 10. The electrical connector is electrically connected to the cell 21 through the through hole.

In this way, the through hole can facilitate a connection between the electrode 211 and the electrical connector 40.

Specifically, in the embodiments of the present disclosure, the first positioning portion 1112 has a first through hole 1114, and the second positioning portion 1213 has a second through hole 1215. The electrode 211 passes through the first through hole 1114 to be electrically connected to the first electrical connector 41, or the electrode 211 passes through the second through hole 1215 to be electrically connected to the second electrical connector 42.

In the embodiments of the present disclosure, the cell 21 has one end penetrating a bottom wall of the first accommodation recess 117 through the first through hole 1114 to be electrically connected to the first electrical connector 41, and another end penetrating a bottom wall of the second accommodation recess 124 through the second through hole 1215 to be electrically connected to the second electrical connector 42.

In other embodiments, the first electrical connector 41 may also penetrate the bottom wall of the first accommodation recess 117 through the first through hole 1114 to be electrically connected to the cell 21, and the second electrical connector 42 may also penetrate the bottom wall of the second accommodation recess 124 through the second through hole 1215 to be electrically connected to the cell 21.

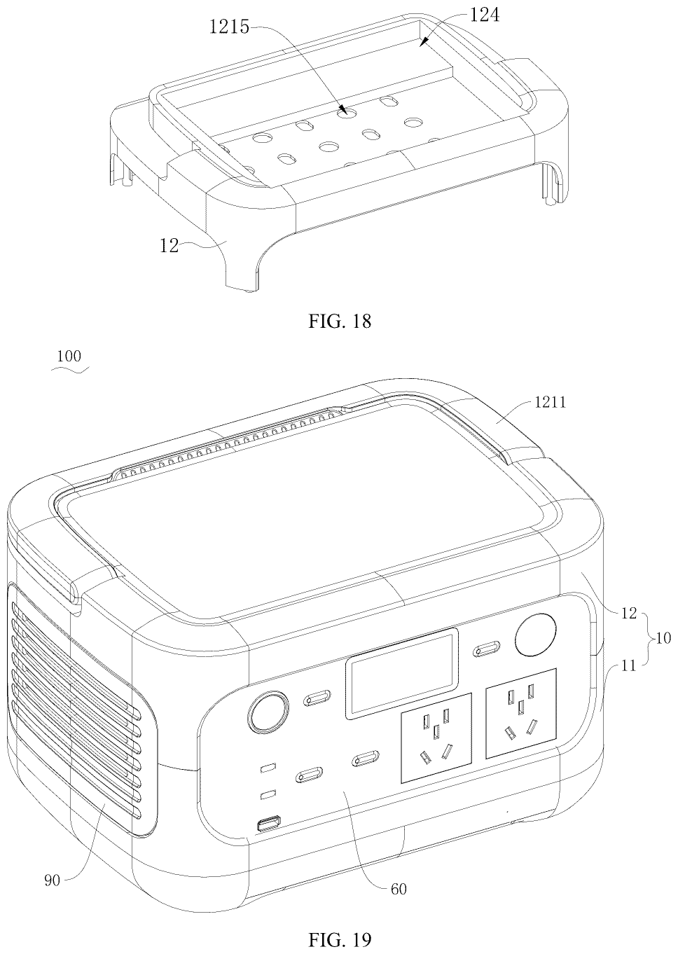

Referring to FIG. 15 and FIG. 18, in some embodiments, the shell 10 has an accommodation recess at an outer side of the shell 10. The electrical connector 40 is disposed in the accommodation recess and electrically connected to the plurality of cells 21.

In this way, the accommodation recess is used to fix the electrical connector 40.

Specifically, in some embodiments, the first case 11 has a first accommodation recess 117 at a side of the first case 11 away from the plurality of cells 21. The first electrical connector 41 is disposed in the first accommodation recess 117 and electrically connected to the plurality of cells 21. The second case 12 has a second accommodation recess 124 at a side of the second case 12 away from the plurality of cells 21. The second electrical connector 42 is disposed in the second accommodation recess 124 and electrically connected to the plurality of cells 21.

In the embodiments of the present disclosure, the first case 11 has an outer side wall recessed inwards to form the first accommodation recess 117. The first electrical connector 41 is disposed in the first accommodation recess 117. The second case 12 has an outer side wall recessed inwards to form the second accommodation recess 124. The second electrical connector 42 is disposed in the second accommodation recess 124. In the embodiments of the present disclosure, the cell 21 has one end penetrating the bottom wall of the first accommodation recess 117 to be electrically connected to the first electrical connector 41, and another end penetrating the bottom wall of the second accommodation recess 124 to be electrically connected to the second electrical connector 42.

In other embodiments, the first electrical connector 41 may also penetrate the bottom wall of the first accommodation recess 117 to be electrically connected to the cell 21, and the second electrical connector 42 may also penetrate the bottom wall of the second accommodation recess 124 to be electrically connected to the cell 21.

In some embodiments, referring to FIG. 17, when the electrodes 211 of the cell 21 are all disposed at one side of the cell 21, the accommodation recess only needs to be formed at one side of the shell 10 to accommodate the electrical connector 40.

Referring to FIG. 13, FIG. 15, and FIG. 18, in some embodiments, the shell 10 further includes a cover plate. The cover plate is connected to the shell 10 and sealingly covers the electrical connector 40 and the through hole.

In this way, the cover plate is used to enclose the electrical connector 40 within the accommodation recess, which is beneficial for protecting the electrical connector 40 and avoiding problems such as corrosion and detachment of the electrical connector 40.

Specifically, in the embodiments of the present disclosure, the shell 10 further includes a first cover plate 118 and a second cover plate 125. The first cover plate 118 is detachably mounted at the first case 11 and covers the first accommodation recess 117. The second cover plate 125 is detachably mounted at the second case 12 and covers the second accommodation recess 124.

In the embodiments of the present disclosure, the first cover plate 118 has an area slightly greater than that of an opening of the first accommodation recess 117. To make a top surface of the first case 11 flat and aesthetically pleasing, an edge of the opening of the first accommodation recess 117 is recessed downwards to form a first mounting recess, and the first cover plate 118 is mounted in the first mounting recess. Similarly, the second cover plate 125 has an area slightly greater than that of an opening of the second accommodation recess 124. To make a top surface of the second case 12 flat and aesthetically pleasing, an edge of the opening of the second accommodation recess 124 is recessed downwards to form a second mounting recess, and the second cover plate 125 is mounted in the second mounting recess.

Further, in the embodiments of the present disclosure, the first cover plate 118 is detachably mounted at the first case 11 by means of a fastener, and the second cover plate 125 is detachably mounted at the second case 12 by means of a fastener. In other embodiments, the first cover plate 118 may also be detachably mounted at the first case 11 by other detachable connection methods such as a snap-fit connection or a mortise-and-tenon connection, and the second cover plate 125 may also be detachably mounted at the second case 12 by other detachable connection methods such as a snap-fit connection or a mortise-and-tenon connection.

Further, in a case where the first cover plate 118 covers the first accommodation recess 117, a sealing ring can be disposed between the first cover plate 118 and the outer side wall of the first case 11 to enhance a sealing effect on the first accommodation recess 117, isolating the first electrical connector 41 in the first accommodation recess 117 from moisture in an ambient environment. In this way, when the energy storage power supply 100 is used in a humid environment, the sealing ring can prevent the moisture from entering the first accommodation recess 117, avoiding rust or even short circuits of the first electrical connector 41 due to the moisture. Similarly, in a case where the second cover plate 125 covers the second accommodation recess 124, a sealing ring can be disposed between the second cover plate 125 and the outer side wall of the second case 12 to enhance a sealing effect on the second accommodation recess 124, isolating the second electrical connector 42 in the second accommodation recess 124 from the moisture in the ambient environment.

In some embodiments, referring to FIG. 17, when the electrodes 211 of the cell 21 are all disposed at one side of the cell, only one cover plate needs to be detachably mounted at the shell 10 to cover the accommodation recess, for a reason that the accommodation recess for accommodating the electrical connector 40 is formed at the one side of the shell 10.

In some embodiments, the inverter 30 includes a substrate 31 and an electronic component disposed at the substrate 31. The substrate 31 has a surface parallel to an extension direction of the cell 21.

In this way, the surface of the substrate 31 being parallel to the extension direction of cell 21 is conducive to reducing a size of the energy storage power supply 100.

Specifically, in some embodiments, the substrate 31 is a Printed Circuit Board (PCB) and is vertically arranged adjacent to the cell 21. The substrate 31 is provided with a plurality of electronic components at a surface of the substrate 31 away from the cell 21.

In some embodiments, the shell 10 has a fixing recess. The substrate 31 is inserted into the fixing recess to fix the inverter 30 to the shell 10.

In this way, using the fixing recess to fix the substrate 31 helps ensure more stable mounting of the substrate 31.

Specifically, in some embodiments, the fixing recess achieves fixation of the inverter 30 through engaging with the substrate 31. Alternatively, the fixing recess may be formed at an inner wall of the first case 11 or an inner wall of the second case 12.

In some embodiments, the first case 11 of the shell 10 has a first fixing recess, and the second case 12 of the shell 10 has a second fixing recess. The substrate 31 is clamped between the first fixing recess and the second fixing recess.

In this way, using the first fixing recess and the second fixing recess to fix the substrate 31 not only facilitates more stable mounting of the substrate 31 but also facilitates fixation of the substrate 31.

Specifically, in some embodiments, the substrate 31 is engaged in the shell 10 through the first fixing recess and the second fixing recess, achieving the fixation of the inverter 30. Alternatively, the first fixing recess is formed at the inner wall of the first case 11, and the second fixing recess is formed at the inner wall of the second case 12.

Referring to FIG. 13, in some embodiments, the energy storage power supply 100 further includes a battery management system 50 electrically connected to the cell 21 and the inverter 30.

In this way, setting up the battery management system 50 is conducive to ensuring safety of the energy storage power supply 100, prolonging a life of the energy storage power supply 100, improving performance of the energy storage power supply 100, and achieving remote monitoring and management of the energy storage power supply 100.

Specifically, the battery management system (BMS) 50 is an intelligent management and maintenance system for each battery unit, which can be regarded as the “brain” of an energy storage system. A main function of the battery management system is to collect data, record relevant data such as voltage, current, temperature, etc., of the cell 21, monitor and estimate a real-time state of the battery, control a charging and discharging process of the battery, perform fault diagnosis and early warning, etc.

In the embodiments of the present disclosure, each of the inverter 30 and the battery management system 50 is disposed between the shell 10 and the cell 21. Further, the inverter 30 and the battery management system 50 are set adjacent to two adjacent side surfaces of the shell 10.

In some embodiments, the energy storage power supply 100 further includes a panel 60, and the first case 11 and the second case 12 define an opening by connecting the first case 11 and the second case 12 to each other. The panel 60 is detachably disposed at the opening 13.

In this way, forming the opening can facilitate mounting of the panel 60 and insertion and a connection of internal wiring in the energy storage power supply 100.

Specifically, in the embodiments of the present disclosure, the shell 10 includes the panel 60 disposed at the opening 13 between the first case 11 and the second case 12. It is conceivable that components like the battery module, the inverter, and the BMS all require wiring insertions and connections. Once the cell 21 is fixed, the shell 10 is basically formed. Therefore, the wiring insertions and connections are unlikely to be performed without forming the opening 13.

Further, the panel 60 can display information such as a current charge level and a battery temperature of the energy storage power supply 100. The panel 60 is further provided with various electrical components, including but not limited to a display screen, a vehicle charging slot, a USB slot, a switch, and an AC socket for a direct connection to the inverter, etc.

In some embodiments, the energy storage power supply 100 further includes a mainboard 70. The mainboard 70 is fixed at a side of the panel 60 adjacent to the shell 10, and is electrically connected to the cell 21.

In this way, the mainboard 70 is used to connect the panel 60 and the cell 21, allowing charging and discharging of the cell 21 to be controlled through operating the mainboard 70 via the panel 60.

In the embodiments of the present disclosure, the mainboard 70 has a vehicle charging port and a USB port that are used for connecting to the BMS. The mainboard 70 is disposed between the panel 60 and the cell 21, and is electrically connected to the cell 21 and the inverter 30. Instructions entered by the operator on the panel 60 can be transmitted through the mainboard 70 to the cell and the inverter 30, controlling the charging process or the discharging process of the cell 21 and the inverter 30.

Third embodiment is described below.

The energy storage power supply 100 according to some embodiments of the present disclosure will be described below with reference to FIG. 19 to FIG. 28.

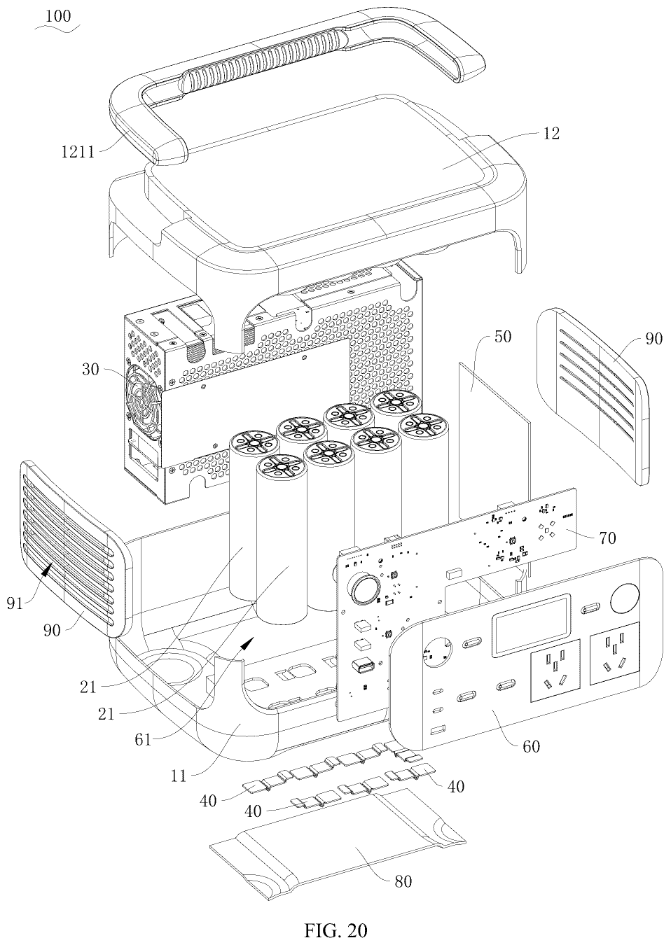

Referring to FIG. 19 and FIG. 20, the energy storage power supply 100 includes the plurality of cells 10, the shell 10, the electrical connector 40, and the inverter 30. The shell 10 has the accommodation cavity 61. The cell 10 is fixed in the accommodation cavity 61. The shell 10 includes the first case 11 and the second case 30.

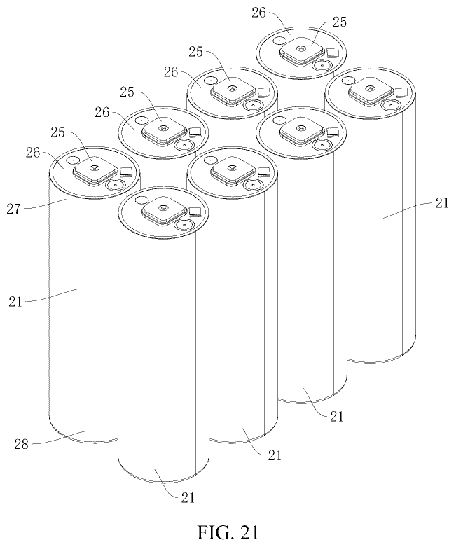

Referring to FIG. 21, the cell 10 includes a positive electrode 25 and a negative electrode 26. Each of the positive electrode 25 and the negative electrode 26 is disposed at a first end 27 of the cell 10.

Referring to FIG. 21 to FIG. 23, the first case 11 is provided with the first positioning portion 1112 at the inner wall of the first case 11. The first positioning portion 1112 has a through hole 14. The cell 10 has the first end 27 inserted into the through hole 14.

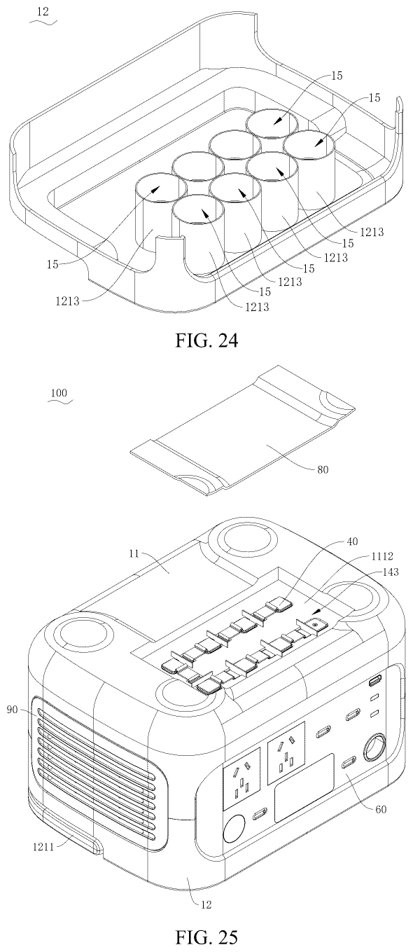

Referring to FIG. 20, FIG. 21, and FIG. 24, the second case 30 is arranged opposite to the first case 11. The second case 30 is provided with the second positioning portion 1213 at an inner wall of the second case 30. The second positioning portion 1213 has an insertion recess 15. The cell 10 has a second end 28 inserted into the insertion recess 15.

Referring to FIG. 21, FIG. 23, and FIG. 25, the electrical connector 40 is located at a side of the first case 11 away from the second case 30. The electrical connector 40 is used for connecting the positive electrode 25 of one cell 10 to the negative electrode 26 of the cell 10 adjacent to the one cell 10.

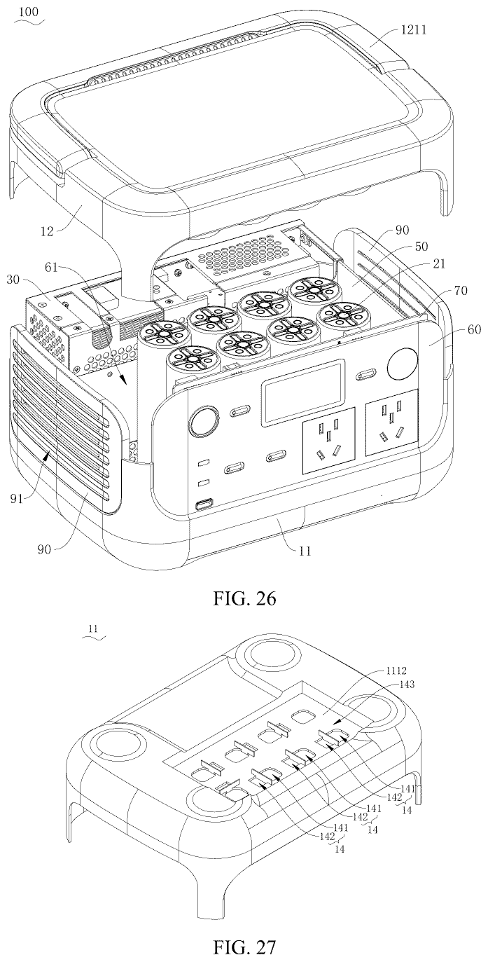

Referring to FIG. 20 and FIG. 26, the inverter 30 is fixed in the accommodation cavity 61 and is electrically connected to the cell 10.

In the above energy storage power supply 100, the first end 27 of the cell 10 is mounted at the first case 11 through the through hole 14, and the second end 28 of the cell 10 is mounted at the second case 30 through the insertion recess 15. In this way, a quantity and types of structural members of the energy storage power supply 100 can be reduced, which can not only reduce assembly steps, but also reduce the size of the energy storage power supply 100.

Specifically, the first end 27 and the second end 28 are arranged oppositely. It should be understood that the first end 27 and the second end 28 may respectively be a lower end and an upper end, a left end and a right end, a front end and a rear end, or two other ends arranged oppositely, depending on factors such as a shape and a placement direction of the cell 10. For example, the cell 10 may be the cylindrical cell 10. The cell 10 may be vertically placed in the first case 11 and the second case 30. The vertical direction corresponds to a length direction of the cell 10. In this case, the first end 27 may be the lower end of the cell 10, and the second end 28 may be the upper end of the cell 10.

The positive electrode 25 and the negative electrode 26 of the cell 10 serve as current interfaces during power supply or charging of the cell 10. Two protrusion posts of different shapes or sizes may be disposed at the first end 27 of the cell 10 and serve as the positive electrode 25 and the negative electrode 26. Alternatively, one protrusion post may be disposed at the first end 27 of the cell 10 and serves as one of the positive electrode 25 and the negative electrode 26. A remaining part of the first end 27 can serve as another of the positive electrode 25 and the negative electrode 26.

The first case 11 and the second case 30 may be arranged oppositely in the vertical direction. The second case 30 may be located above or below the first case 11. In the embodiments of the present disclosure, the second case 30 is located above the first case 11. The first case 11 may be formed by a bottom wall and a plurality of side walls extending upwards from edges of the bottom wall. The first positioning portion 1112 may be disposed at an upper surface of the first case 11, i.e., a surface of the bottom wall of the first case 11 that is adjacent to the second case 30. The second case 30 may be formed by a top wall and a plurality of side walls extending downwards from edges of the top wall. The second positioning portion 1213 may be disposed at a lower surface of the second case 30, i.e., a surface of the top wall of the second case 30 that is adjacent to the first case 11.

The through hole 14 may include a first aperture 141 and a second aperture 142. The positive electrode 25 may be inserted into the first aperture 141. The negative electrode 26 may be inserted into the second aperture 142. A shape of the first aperture 141 may match that of the positive electrode 25. A shape of the second aperture 142 may match that of the negative electrode 26. The first aperture 141 is spaced apart from the second aperture 142. In addition, each of the first aperture 141 and the second aperture 142 has a size smaller than that of the cell 10 to prevent the cell 10 from slipping out of the first aperture 141 or the second aperture 142.

The electrical connector 40 may be made of copper, aluminum, nickel, or an alloy, and can be welded to the positive electrode 25 and the negative electrode 26 of the cell 10 through laser welding. It should be understood that other connection methods such as twisting or pressing can also achieve an electrical connection between the electrical connector 40 and each of the positive electrode 25 and the negative electrode 26 of the cell 10. A plurality of electrical connectors 40 may be provided. The plurality of cells 10 may be connected in series by the plurality of electrical connectors 40.

The inverter 30 may be fixed to the first case 11 by a clip or a screw. The inverter 30 being electrically connected to the cell 10 means that the inverter 30 and the cell 10 can be connected via physical wiring capable of transmitting electrical signals, such as PCB copper foil or wires.

Referring to FIG. 21 to FIG. 24, in some embodiments, a plurality of through holes 14 and a plurality of insertion recesses 15 may be formed. Each of the plurality of through holes 14 and the plurality of insertion recesses 15 corresponds to the plurality of cells 10 in one-to-one correspondence.

In this way, the first end 27 of each cell 10 can be inserted into one through hole 14, and the second end 28 of each cell 10 can be inserted into one insertion recess 15, which helps improve stability of each cell 10 in the energy storage power supply 100.

Specifically, three cells 10, four cells 10, five cells 10, six cells 10, seven cells 10, eight cells 10, or the like may be provided. In an embodiment, eight cells 10 are provided, and correspondingly eight through holes 14 and eight insertion recesses 15 are formed. The first ends 27 of the eight cells 10 are respectively inserted into the eight through holes 14, while the second ends 28 of the eight cells 10 are respectively inserted into the eight insertion recesses 15.

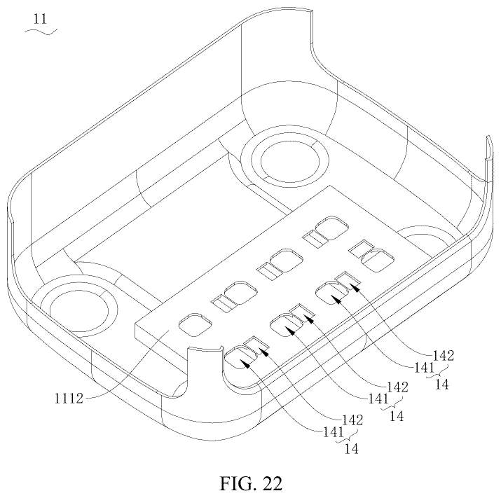

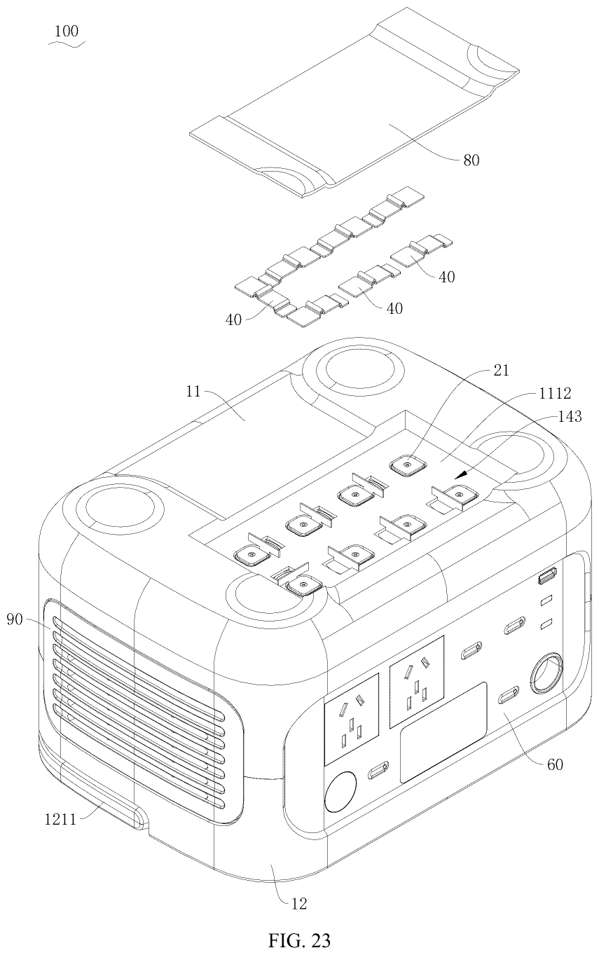

Referring to FIG. 22, in some embodiments, the first positioning portion 1112 and the first case 11 have an integral structure.

In this way, the quantity and the types of the structural members of the energy storage power supply 100 can be reduced, which can not only reduce the assembly steps, but also reduce the size of the energy storage power supply 100, improving overall strength.

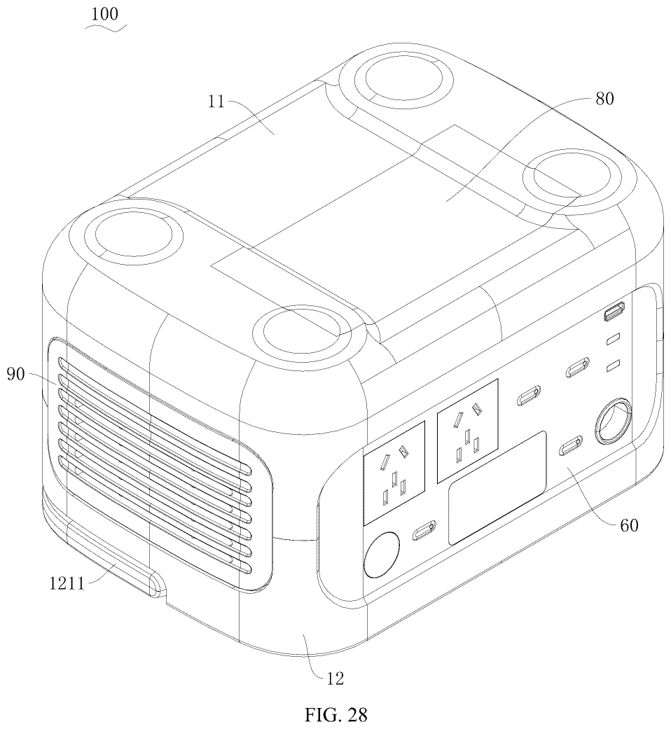

Specifically, in combination with FIG. 22 and FIG. 27, in some embodiments, the first positioning portion 1112 is of a plate-like shape, the upper surface of the first case 11 may have a mounting hole 143 extending downwards, and the first positioning portion 1112 covers the mounting hole 143. In combination with FIG. 21 and FIG. 23, the positive electrode 25 and the negative electrode 26 may protrude from the through holes 14, and may be partially located in the mounting hole 143 or may be located in the through hole 14. When the positive electrode 25 is a protrusion post and the remaining part of the first end 27 of the cell 10 is the negative electrode 26, the positive electrode 25 may protrude from the through hole 14 and be partially located in the mounting hole 143, and the negative electrode 26 is located in the through hole 14. The mounting hole 143 may be in a square shape. The first positioning portion 1112 may have a square plate-like shape structure, and a size that may be greater than or equal to a size of the mounting hole 143.

In an embodiment, the first positioning portion 1112 may have a tubular structure formed by the upper surface of the first case 11 extending upwards. An inner surface of the first positioning portion 1112 and an upper surface of the first case 11 together define a mounting recess. A part of the upper surface of the first case 11 corresponding to the first positioning portion 1112 may have the through hole 14 extending downwards. The first positioning portion 1112 has an inner diameter that may be slightly greater than or equal to a diameter of the first end 27 of the cell 10. That is, the mounting recess has a diameter that may be slightly greater than or equal to the diameter of the first end 27 of the cell 10. In this way, the first end 27 of the cell 10 can be inserted into the mounting recess.

The first positioning portion 1112 and the first case 11 having the integral structure may mean that the first positioning portion 1112 and the first case 11 are integrally formed, or that the first positioning portion 1112 and the first case 11 are formed into an integral body through methods such as welding, bonding, etc.

Referring to FIG. 24, in some embodiments, the second positioning portion 1213 is of tubular shape, and the second positioning portion 1213 and the second case 30 have an integral structure.

In this way, the quantity and the types of the structural members of the energy storage power supply 100 can be reduced, which can not only reduce the assembly steps, but also reduce the size of the energy storage power supply 100, improving the overall strength.

Specifically, the second positioning portion 1213 may have a tubular structure formed by the lower surface of the second case 30 extending downwards. An inner surface of the second positioning portion 1213 and a lower surface of the second case 30 together define the insertion recess 15. The second positioning portion 1213 has an inner diameter that may be slightly greater than or equal to a diameter of the second end 28 of the cell 10. That is, the insertion recess 15 has a diameter that may be slightly greater than or equal to the diameter of the second end 28 of the cell 10. In this way, the second end 28 of the cell 10 can be inserted into the insertion recess 15.

The second positioning portion 1213 and the second case 30 having the integral structure may mean that the second positioning portion 1213 and the second case 30 are integrally formed, or that the second positioning portion 1213 and the second case 30 are formed into an integral body through methods such as welding, bonding, etc.

Referring to FIG. 25 and FIG. 28, in some embodiments, the energy storage power supply 100 includes a cover plate 80. The cover plate 80 covers the electrical connector 40.

In this way, the cover plate 80 can protect the electrical connector 40 to reduce a risk of a deformation or a detachment of the electrical connector 40 caused by external collisions, enhancing stability of the energy storage power supply 100.

Specifically, the cover plate 80 may be disposed in the mounting hole 143, and has a shape and a dimension that may match those of the mounting hole 143. The cover plate 80 may be fixed to the first case 11 through a bolt. Each of the cover plate 80, the first case 11, and the second case 30 may be made of a material having satisfactory thermal conductivity such as aluminum, to transfer heat generated during the charging or the discharging of the cell 10 to an outside of the energy storage power supply 100.

In an embodiment, the energy storage power supply 100 further includes a sealing ring. The sealing ring is connected to the cover plate 80 and a side wall forming the mounting hole 143, improving sealing effectiveness of the mounting hole 143 and reducing a risk of moisture ingress that leads to corrosion or even short circuits of the electrical connector 40.

Referring to FIG. 20 and FIG. 26, in some embodiments, the energy storage power supply 100 includes a decorative cover 90 and a panel 60. The decorative cover 90 and the panel 60 are disposed between the first case 11 and the second case 30 and connected to the first case 11 and the second case 30. The first case 11, the second case 30, the decorative cover 90, and the panel 60 define the accommodation cavity 61. The decorative cover 90 has a vent 91 in communication with the accommodation cavity 61.

In this way, the decorative cover 90 can not only beautify an appearance, but also increase air circulation between an inside of the accommodation cavity 61 and the ambient environment, preventing an excessive temperature in the accommodation cavity 61 from affecting an operation of electronic components.

Specifically, two decorative covers 90 may be provided. The two decorative covers 90 may be mounted at a left side and a right side of the energy storage power supply 100, respectively. The decorative cover 90 may be connected to the first case 11 and the second case 30 through a snap-fit connection or a fastener like a bolt, or may be integrally formed with the first case 11 or the second case 30.

The panel 60 can display information such as a current charge level and a temperature of the cell 10 in the energy storage power supply 100. The panel 60 may further have a port for connecting the energy storage power supply 100 to an electrical device or a charging device, allowing the cell 10 to supply power to the electrical device or be charged by the charging device. The panel 60 may be connected to the first case 11 and the second case 30 through a snap-fit connection or a fastener like a bolt, or may be integrally formed with the first case 11 or the second case 30.

Referring to FIG. 20 and FIG. 26, in some embodiments, the energy storage power supply 100 includes a mainboard 70 disposed in the accommodation cavity 61 and located at a side of the cell 10. The mainboard 70 is connected to the panel 60 and electrically connected to the cell 10.

In this way, the mainboard 70 can obtain a user instruction through a user input interface to control the charging process or the discharging process of the cell 10.

Specifically, an external plug-in member may penetrate the panel 60 to be plugged into the mainboard 70. The panel 60 can isolate the mainboard 70 to reduce a risk of electric shock to the user. The mainboard 70 may be connected to the panel 60 at a side of the panel 60 facing towards the cell 10 through a snap-fit connection or a fastener like a screw. That is, the mainboard 70 is located between the panel 60 and the cell 10. The mainboard 70 being electrically connected to the cell 10 means that the mainboard 70 and the cell 10 can be connected via physical wiring capable of transmitting electrical signals, such as PCB copper foil or wires.

Referring to FIG. 20 and FIG. 26, in some embodiments, the inverter 30 is disposed at a side of the cell 10 and is electrically connected to the mainboard 70.

In this way, the inverter 30 can be used to convert a direct current generated by the cell 10 into an alternating current for use by the electrical device.

Specifically, the inverter 30 may be disposed at a side of the cell 10 away from the mainboard 70, or the inverter 30 may be disposed between the mainboard 70 and the cell 10. The inverter 30 being electrically connected to the mainboard 70 means that the inverter 30 and the mainboard 70 can be connected via physical wiring capable of transmitting electrical signals, such as PCB copper foil or wires.

Referring to FIG. 20 and FIG. 26, in some embodiments, the energy storage power supply 100 includes the battery management system 50 disposed in the accommodation cavity 61 and located at a side of the cell 10. The battery management system 50 is electrically connected to the cell 10.

In this way, the battery management system 50 can be used to monitor state information of the cell 10, such as current, temperature, or voltage, to prevent situations such as overcharging, over-discharging, or short circuits of the cell 10, protecting the cell 10 from damages.

Specifically, the battery management system 50 may be disposed between the decorative cover 90 and the cell 10 or between the mainboard 70 and the cell 10. The battery management system 50 being electrically connected to the cell 10 means that the battery management system 50 and the cell 10 can be connected via physical wiring capable of transmitting electrical signals, such as PCB copper foil or wires.

In an embodiment, the battery management system 50 is located between the cell 10 and the inverter 30.

Referring to FIG. 20 and FIG. 26, in some embodiments, the energy storage power supply 100 includes the handle 1211. The handle 1211 is rotatably disposed at the second case 30.

In this way, the energy storage power supply 100 is convenient to carry, which makes the energy storage power supply 100 labor-saving and practical.

Specifically, the handle 1211 may be U-shaped. The handle 1211 can be folded and stored in a groove formed by the second case 30. The handle 1211 may be integrally formed from a hollow aluminum material, which can reduce a weight of the energy storage power supply 100 while ensuring support strength.

In the present disclosure, the term “a plurality of” means two or more, unless otherwise specifically defined. Terms such as “install”, “connect”, “connect to”, and “fix” should be understood in a broad sense. For example, it may be a fixed connection or a detachable connection or connection as one piece; direct connection or indirect connection through an intermediate. For those of ordinary skill in the art, the specific meaning of the above-mentioned terms in the present disclosure can be understood according to specific circumstances.

Reference throughout this specification to “an embodiment”, “some embodiments”, “a specific embodiment”, or the like means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples. Although some embodiments of the present disclosure are described above, the present disclosure is not limited to these embodiments. For those skilled in the art, various changes and variations can be made to the present disclosure. Any modifications, equivalent substitutions, improvements, or the like made within the spirit and principles of the present disclosure shall be included in the scope of protection of the present disclosure.

What is claimed is:

1. An energy storage power supply, comprising:
a shell comprising a first case and a second case detachably connected to the first case, wherein the first case has a first inner wall opposite to the second case and is provided with a first positioning portion at the first inner wall, and wherein the second case has a second inner wall opposite to the first case and is provided with a second positioning portion at the second inner wall;
a battery module comprising a plurality of cells, each of the plurality of cells having two ends that are inserted into the first positioning portion and the second positioning portion, respectively; and
an inverter disposed in the shell and electrically connected to the battery module.

2. The energy storage power supply according to claim 1, wherein:
the first case comprises a bottom housing;
the first inner wall comprises an inner bottom wall of the shell;
the second case comprises a top housing; and
the second inner wall comprises an inner top wall of the shell.

3. The energy storage power supply according to claim 1, wherein:
the first case comprises a plurality of first connection posts; and
the second case comprises a plurality of second connection posts, the plurality of first connection posts being connected to the plurality of second connection posts when the first case is connected to the second case.

4. The energy storage power supply according to claim 1, further comprising an electrical connector, wherein:
the cell comprises a positive electrode and a negative electrode that are respectively located at the two ends of the cell, wherein the electrical connector is disposed at the first positioning portion and the second positioning portion to connect electrodes of multiple adjacent cells of the plurality of cells at one side of the multiple adjacent cells; or
the cell comprises a positive electrode and a negative electrode that are located at one side of the cell, wherein the electrical connector is disposed at the first positioning portion or the second positioning portion to connect the positive electrode of one cell of the plurality of cells to the negative electrode of another cell of the plurality of cells.

5. The energy storage power supply according to claim 1, wherein:
the first positioning portion has a plurality of first positioning recesses, one end of the cell being inserted into a corresponding first positioning recess of the plurality of first positioning recesses; and
the second positioning portion has a plurality of second positioning recesses corresponding to the plurality of first positioning recesses, respectively, another end of the cell being inserted into a corresponding second positioning recess of the plurality of second positioning recesses.

6. The energy storage power supply according to claim 4, wherein:
the shell has an accommodation recess at an outer side of the shell, the electrical connector being disposed in the accommodation recess and electrically connected to the plurality of cells;
the first positioning portion has a through hole, one end of the cell being inserted into the through hole, and the electrical connector being electrically connected to the cell through the through hole; and
the second positioning portion has an insertion recess, another end of the cell being inserted into the insertion recess.

7. The energy storage power supply according to claim 6, wherein:
the first positioning portion has a plurality of through holes, the plurality of through holes corresponding to the plurality of cells in one-to-one correspondence; and
the second positioning portion has a plurality of insertion recesses, the plurality of insertion recesses corresponding to the plurality of cells in one-to-one correspondence.

8. The energy storage power supply according to claim 1, wherein the first positioning portion is of a plate-like shape, the first positioning portion and the first case being integrally formed.

9. The energy storage power supply according to claim 1, wherein the second positioning portion is of tubular shape, the second positioning portion and the second case being integrally formed.

10. The energy storage power supply according to claim 1, wherein the battery module comprises a first battery module and a second battery module stacked together, wherein:
the first battery module comprises a first bracket connected to the first case and several cells of the plurality of cells, wherein the first bracket is provided with a third positioning portion, each of the several cells of the first battery module having two ends that are inserted into the first positioning portion and the third positioning portion, respectively; and
the second battery module comprises a second bracket connected to the second case and several cells of the plurality of cells, wherein the second bracket is provided with a fourth positioning portion, each of the several cells of the second battery module having two ends that are inserted into the second positioning portion and the fourth positioning portion, respectively.

11. The energy storage power supply according to claim 10, wherein:
each of the plurality of cells is provided with two electrodes at a first end of the cell; and
the energy storage power supply further comprises an electrical connector, the electrical connector being disposed at each of the first bracket and the second bracket to connect electrodes of multiple adjacent cells of the plurality of cells at one side of the multiple adjacent cells.

12. The energy storage power supply according to claim 6, wherein the shell further comprises a cover plate, the cover plate being connected to the shell and sealingly covering the electrical connector and the through hole.

13. The energy storage power supply according to claim 1, wherein:
the shell has an accommodation cavity, the battery module and the inverter being fixed in the accommodation cavity;
the energy storage power supply further comprises a decorative cover disposed between the first case and the second case and connected to the first case and the second case, the decorative cover having a vent in communication with the accommodation cavity;
the energy storage power supply further comprises a panel, the accommodation cavity being defined by the first case, the second case, the decorative cover, and the panel; and
the first case and the second case define an opening by connecting the first case and the second case to each other, the panel being detachably disposed at the opening.

14. The energy storage power supply according to claim 13, further comprising a mainboard disposed in the accommodation cavity and located at a side of the battery module, the mainboard being connected to the panel and electrically connected to the battery module.

15. The energy storage power supply according to claim 1, wherein the inverter comprises a substrate and an electronic component disposed at the substrate, the substrate having a surface parallel to an extension direction of the cell.

16. The energy storage power supply according to claim 15, wherein the shell has a fixing recess, the substrate being inserted into the fixing recess to fix the inverter to the shell.

17. The energy storage power supply according to claim 16, wherein:
the inverter is disposed at a side of the battery module;
the first case has a first fixing recess; and
the second case has a second fixing recess, the substrate being clamped between the first fixing recess and the second fixing recess.

18. The energy storage power supply according to claim 1, further comprising a battery management system disposed in the accommodation cavity formed by the shell and located at a side of the battery module, the battery management system being electrically connected to the battery module and the inverter.

19. An energy storage power supply, comprising:
a shell comprising a first case and a second case detachably connected to the first case, wherein the first case has a first inner wall opposite to the second case and is provided with a first positioning portion at the first inner wall, and wherein the second case has a second inner wall opposite to the first case;
a plurality of cells, wherein each of the plurality of cells has one end inserted into the first positioning portion and another end abutting with the second inner wall to allow the plurality of cells to be fixed to the first positioning portion; and
an inverter disposed in the shell and electrically connected to the plurality of cells.
